(19) United States
(12) Patent Application Publication
(10) Pub. No.: US 2024/0336283 A1
(43) Pub. Date: Oct. 10, 2024

(54) AUTOMATIC SYSTEM FOR GETTING OUT OF PARKING AREA AND AUTOMATIC METHOD FOR GETTING OUT OF PARKING AREA

(71) Applicant: J-QuAD DYNAMICS Inc., Tokyo (JP)

(72) Inventors: Suguru SAKAI, Tokyo (JP); Hiroki Inagaki, Tokyo (JP); Tomoyuki Matsuba, Tokyo (JP)

(21) Appl. No.: 18/747,327

(22) Filed: Jun. 18, 2024

Related U.S. Application Data
(63) Continuation of application No. PCT/JP2022/047507, filed on Dec. 23, 2022.

(30) Foreign Application Priority Data
Dec. 23, 2021 (JP) 2021-209843

(51) Int. Cl. B60W 60/00; G01C 21/34; G06T 7/70; H04W 4/029; H04W 4/40

(52) U.S. Cl. CPC B60W 60/0025; G01C 21/3407; G06T 7/70; H04W 4/029; H04W 4/40

(57) ABSTRACT

A vehicle automatically gets out of a parking area toward a location required by an user. A relative position between a communication terminal carried by the user and the vehicle is determined according to one of detection processes corresponding to a communication state between the communication terminal and one or more of sensor units on the vehicle. An out-of-parking target position is set based on a detection result of the position detection, and an optimum out-of-parking target position is calculated by updating the out-of-parking target position when the position detection has a higher reliability than the currently set out-of-parking target position while getting out of the parking area. An autonomous driving operation of the vehicle is controlled to get out of the parking area toward the out-of-parking target position.

### CROSS REFERENCE TO RELATED APPLICATIONS

The present application is a continuation application of International Patent Application No. PCT/JP2022/047507 filed on Dec. 23, 2022, which designated the U.S. and claims the benefit of priority from Japanese Patent Application No. 2021-209843 filed on Dec. 23, 2021. The entire disclosures of all of the above applications are incorporated herein by reference.

### TECHNICAL FIELD

The present disclosure relates to an automatic system for getting out of a parking area and an automatic method for getting out of a parking area.

### BACKGROUND

Conventionally, there is known a technique for remotely controlling a parked vehicle by a communication terminal to automatically position the vehicle at an exit position according to a conceivable technique. In the conceivable technique, the exit position of the vehicle is determined based on the position of the parked vehicle and the position of the user carrying the communication terminal. Then, the vehicle is automatically driven out of the parking area toward the exit position.

### SUMMARY

According to an example, a vehicle automatically gets out of a parking area toward a location required by an user. A relative position between a communication terminal carried by the user and the vehicle is determined according to one of detection processes corresponding to a communication state between the communication terminal and one or more of sensor units on the vehicle. An out-of-parking target position is set based on a detection result of the position detection, and an optimum out-of-parking target position is calculated by updating the out-of-parking target position when the position detection has a higher reliability than the currently set out-of-parking target position while getting out of the parking area. An autonomous driving operation of the vehicle is controlled to get out of the parking area toward the out-of-parking target position.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a configuration diagram of an automatic system for getting out of a parking area according to a first embodiment;

FIGS. 2A and 2B are explanatory diagrams showing a first distance measurement process;

FIGS. 3A and 3B are explanatory diagrams showing a direction detection process;

FIGS. 4A and 4B are explanatory diagrams showing a second distance measurement process;

FIG. 5A is a schematic diagram showing a case where a digital key is registered in a communication terminal, and FIG. 5B is a schematic diagram showing a case where a pairing is set between a vehicle and a communication terminal;

FIG. 6 is a diagram showing a screen of a preparation for automatically getting out of a parking area displayed on a communication terminal;

FIG. 7 is a procedure diagram showing the flow of the automatically getting out of the parking area;

FIG. 8 is a diagram showing a check screen displayed on a communication terminal;

FIG. 9 is a configuration diagram of an automatic system for getting out of a parking area according to a second embodiment;

FIG. 10 is a diagram showing a specific example of capturing an image of a parked vehicle with a communication terminal;

FIG. 11 is a schematic diagram showing a case where information of a relative position is transmitted from a communication terminal to a vehicle;

FIG. 12 is an explanatory diagram showing a specific example of the automatically getting out of the parking area when the vehicle is parked backwards in another example;

FIG. 13 is a diagram showing a confirmation screen displayed on a communication terminal in another example; and

FIG. 14 is an explanatory diagram of another example in which the automatically getting out of the parking area is performed so that a rear of the vehicle is disposed in front of the user.

### DETAILED DESCRIPTION

Each of the vehicle and the communication terminal calculates its own absolute position using a Global Positioning System (i.e., GPS). During the process for getting out of the parking area, the exit position is determined by calculating the relative position relationship between the absolute position of the vehicle and the absolute position of the communication terminal. For this reason, since it may not be possible to detect the absolute position inside a building and the like, there is a possibility not executing the automatic getting out of the parking area. Furthermore, since it may not be possible to detect a precise position in case of the absolute position, there is a difficulty with respect to an accuracy of the getting out of the parking area.

Present embodiments are to provide an automatic system for getting out of a parking area and an automatic method for getting out of a parking area with improving an accuracy of arrival at a location intended by a user when automatically getting out of a parking area.

The automatic system for getting out of a parking area that solves the above difficulty is configured to automatically drive a vehicle to a location required by an user when requesting the getting out of the parking area with respect to a parked vehicle.

The automatic system includes: a position detection unit that detects a relative position between a communication terminal carried by the user and the vehicle according to any one of a plurality of detection processes corresponding to a communication state among the plurality of detection processes using a wireless communication between the communication terminal and one or more sensor units mounted on a vehicle body; an out-of-parking target calculation unit that sets an out-of-parking target position based on a detection result of the position detection unit, and calculates an optimum out-of-parking target position by updating the out-of-parking target position based on the detection result of the position detection unit when a position detection is performed in the any one of the plurality of detection processes with a reliability higher than the out-of-parking target position currently being set while getting out of the parking area; and a vehicle control unit that controls an autonomous driving operation of the vehicle to be driven toward the out-of-parking target position.

The automatic method for getting out of a parking area that solves the above difficulty is configured to be used in an automatic system for automatically driving a vehicle to a location required by an user when requesting the getting out of the parking area with respect to a parked vehicle.

The automatic method includes: detecting a relative position between a communication terminal carried by the user and the vehicle according to any one of a plurality of detection processes corresponding to a communication state among the plurality of detection processes using a wireless communication between the communication terminal and one or more sensor units mounted on a vehicle body; setting an out-of-parking target position based on a detection result of the any one of a plurality of detection processes; calculating an optimum out-of-parking target position by updating the out-of-parking target position based on the detection result of the any one of a plurality of detection processes when a position detection is performed in the any one of the plurality of detection processes with a reliability higher than the out-of-parking target position currently being set while getting out of the parking area; and controlling an autonomous driving operation of the vehicle to be driven toward the out-of-parking target position.

According to the present embodiments, the position relationship between the vehicle as an out-of-parking object and the communication terminal is acquired according to a relative position, and the out-of-parking target position when automatically getting out of the parking area is calculated based on the relative position. Therefore, even if the vehicle is parked inside a building, it is possible to automatically get out of the parking area. Further, the out-of-parking target position as a driving target position of the vehicle when automatically getting out of the parking area is updated, so that the optimum out-of-parking target position is set each time. Thus, the out-of-parking target position is optimized. As a result, it is possible to improve the accuracy of arrival at a location intended by a user when automatically getting out of a parking area.

### First Embodiment

The first embodiment of the present disclosure will be described below.

### (Overall Configuration of Autonomous Driving System 1)

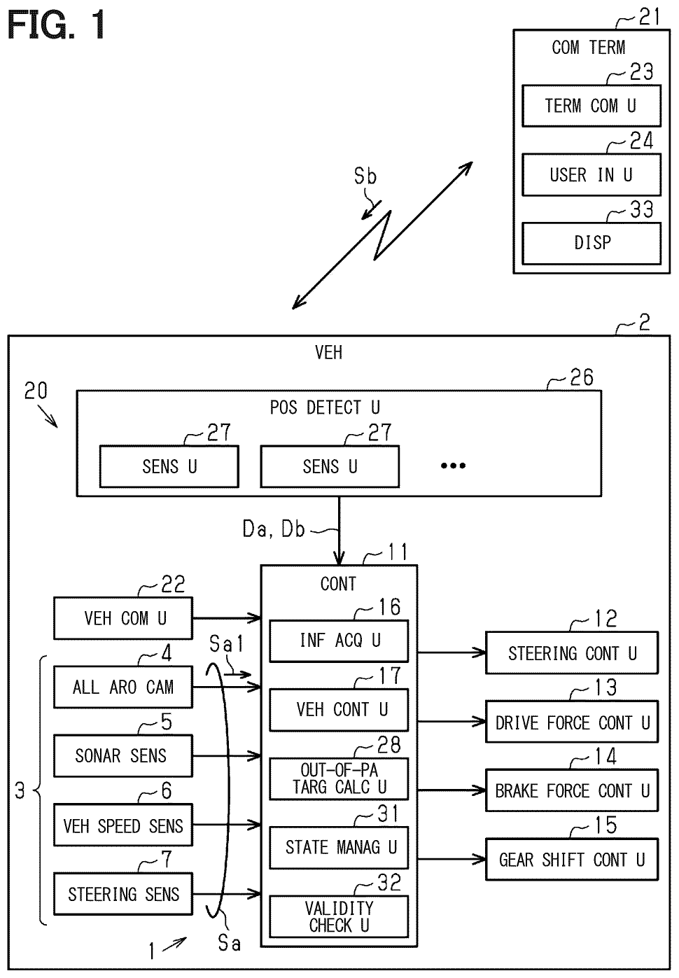

As shown in FIG. 1, a vehicle 2 is equipped with an autonomous driving system 1 that automatically drives the vehicle 2. The autonomous driving system 1 automatically drives the vehicle 2 to the destination without a driving operation of the driver by causing a computer to execute the acceleration/deceleration, the braking, and the steering of the vehicle 2. The vehicle 2 may be any of an electric vehicle, a hybrid vehicle, a gasoline vehicle, a fuel cell vehicle, and a hydrogen vehicle.

The autonomous driving system 1 includes a detection unit 3 provided in a vehicle 2 to acquire information about the situation around the vehicle. The detection unit 3 includes, for example, an all around camera 4, a sonar sensor 5, a vehicle speed sensor 6, and a steering sensor 7. The all around camera 4 captures an image of a periphery of the vehicle 2. The sonar sensor 5 is, for example, an ultrasonic sensor arranged at each of the four corners of the vehicle body 8, and detects an obstacle disposed around the vehicle 2. The vehicle speed sensor 6 detects a traveling speed of vehicle 2. The steering sensor 7 detects the amount of steering of the steering wheel of the vehicle 2.

The autonomous driving system 1 includes a controller 11 that controls the autonomous driving operation of the vehicle 2. The input side of the controller 11 is connected to the detection unit 3 (including the all around camera 4, the sonar sensor 5, the vehicle speed sensor 6, and the steering sensor 7). The output side of the controller 11 is connected to a steering control unit 12 that controls the amount of steering of the turning wheels of the vehicle 2, a drive force control unit 13 that controls the acceleration and the deceleration of the vehicle 2, a brake force control unit 14 that controls the brake force (i.e., braking force) applied to the vehicle 2, and a gear shift control unit 15 that controls the transmission of the vehicle 2.

The controller 11 includes an information acquisition unit 16 that acquires vehicle periphery information Sa from the detection unit 3. The vehicle periphery information Sa includes, for example, photograph information Sa1 captured by the all-around camera 4, information about the periphery of the four corners of the vehicle body detected by the sonar sensor 5, vehicle speed information detected by the vehicle speed sensor 6, and steering information detected by the steering sensor 7.

The controller 11 includes a vehicle control unit 17 that controls the autonomous driving operation of the vehicle 2. The vehicle control unit 17 controls the steering control unit 12, the drive force control unit 13, the brake force control unit 14, and the shift control unit 15 based on information input from the all-around camera 4, the sonar sensor 5, the vehicle speed sensor 6, and the steering sensor 7, thereby causing the vehicle 2 to drive autonomously.

### (Overall Configuration of the Automatic System 20 for Getting Out of Parking Area)

As shown in FIG. 1, the automatic system 20 for getting out of parking area has an automatic getting out of parking area function (i.e., the automatic system 20 for getting out of parking area) that automatically causes the parked vehicle 2 to get out of the parking area when an instruction for getting out of a parking area with respect to the parked vehicle is received. In this example, when a request Sb for getting out of a parking area with respect to the vehicle 2 is received, the automatic system 20 for getting out of parking area causes the vehicle 2 to automatically get out of the parking area.

to a location required by an user. The request Sb for getting out of a parking area is notified to the vehicle 2 from the communication terminal 21.

The vehicle 2 is equipped with a vehicle communication unit 22 that performs wireless communication with the communication terminal 21. The vehicle communication unit 22 has, for example, a Bluetooth (registered trademark) communication function. For the Bluetooth communication, it may be preferable to use, for example, BLE (i.e., Bluetooth Low Energy). The communication terminal 21 includes a terminal communication unit 23 that performs wireless communication with the vehicle 2. The terminal communication unit 23 has a Bluetooth communication function and executes Bluetooth communication with the vehicle 2. The terminal communication unit 23 transmits the request Sb for getting out of a parking area to the vehicle 2 via the Bluetooth communication. The vehicle 2 receives this request Sb for getting out of a parking area via the vehicle communication unit 22.

The communication terminal 21 may be preferably, for example, a mobile terminal. The mobile terminal is, for example, a high-performance mobile phone. The communication terminal 21 is provided with a user input unit 24 used for operations for automatically getting out of the parking area. The user input unit 24 may be, for example, a touch sensor that detects a touch operation of the user on the screen of the communication terminal 21, or may be a mechanical switch provided in the communication terminal 21.

### (Main Configuration Elements of the Automatic System 20 for Getting Out of Parking Area)

As shown in FIG. 1, the automatic system 20 for getting out of parking area includes a position detection unit 26 that detects the relative position between the vehicle 2 and the communication terminal 21 via wireless communication with the communication terminal 21. The position detection unit 26 detects a relative position between a communication terminal 21 carried by the user and the vehicle 2 according to any one of a plurality of detection processes corresponding to a communication state among the plurality of detection processes using a wireless communication between the communication terminal 21 and one or more sensor units 27 mounted on a vehicle body 8. The relative position is, for example, the relative position of the communication terminal 21 when measuring from the sensor unit 27. When the vehicle gets out of the parking area, the position detection unit 26 periodically and repeatedly detects the relative position.

The sensor unit 27 is, for example, a ToF (i.e., Time of Flight) sensor. In this example, the detection of the relative position is executed by performing position detection communication through UWB (i.e., Ultra Wide Band) communication. In this case, each of the sensor units 27 has a communication function for the UWB communication. Furthermore, the terminal communication unit 23 has a communication function of the UWB communication for detecting the relative position, in addition to a communication function of the Bluetooth communication.

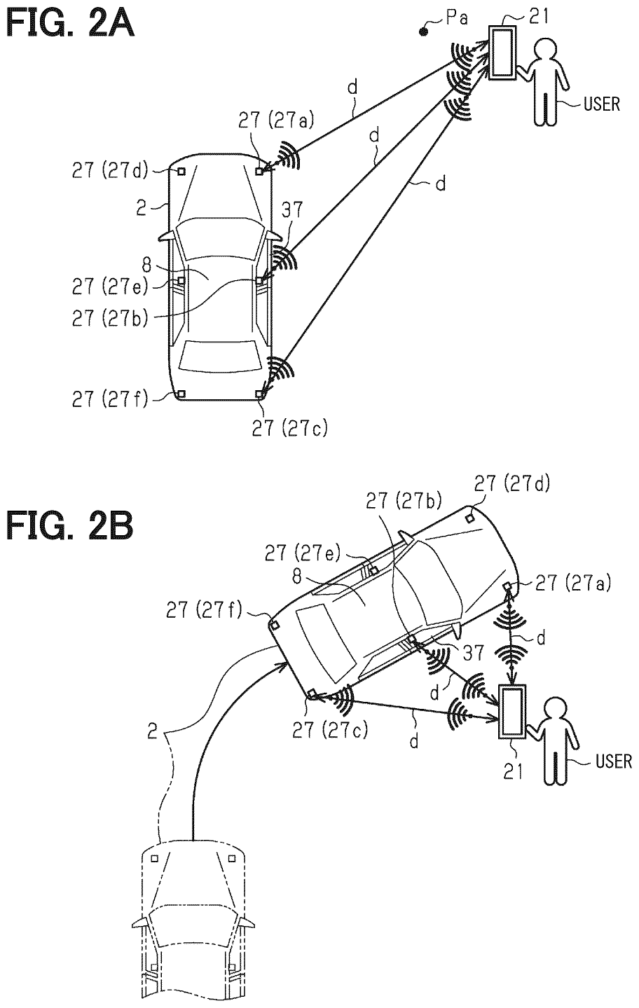

As shown in FIG. 2A and other drawings, the sensor unit 27 is disposed at a specified position on the vehicle body 8. Specifically, multiple sensor units 27 may be preferably disposed at positions that are symmetrical on the right and left sides of the vehicle body 8. In this example, the sensor unit 27 includes a right front sensor unit 27a disposed on the front right of the vehicle body 8, a right center sensor unit 27b disposed on the center right of the vehicle body 8, and a right rear sensor unit 27c disposed on the rear right of the vehicle body 8. The sensor unit 27 further includes a left front sensor unit 27d disposed on the front left of the vehicle body 8, a left center sensor unit 27e disposed on the center left of the vehicle body 8, and a left rear sensor unit 27f disposed on the rear left of the vehicle body 8.

As shown in FIG. 1, the automatic system 20 for getting out of a parking area includes an out-of-parking target calculation unit 28 that calculates a out-of-parking target position Pa based on the detection result of the position detection unit 26. The out-of-parking target calculation unit 28 is provided in the controller 11. The out-of-parking target calculation unit 28 sets the out-of-parking target position Pa (shown in FIG. 2A and the like) from the detection result of the position detection unit 26, and appropriately calculates the optimal out-of-parking target position Pa by updating the out-of-parking target position Pa based on the detection result when a position detection is performed in a detection process with a reliability higher than the out-of-parking target position Pa currently being set while getting out of the parking area. Then, the vehicle control unit 17 controls the out-of-parking travel of the vehicle 2 so that the vehicle 2 is driven toward the out-of-parking target position Pa.

### (Specific Example of Detection Process)

As shown in FIGS. 2A and 2B, the detection process includes a distance measurement detection process of detecting a distance d between the communication terminal 21 and the sensor unit 27 by the wireless communication and determining the relative position of the vehicle 2 and the communication terminal 21. The distance measurement detection process includes a first distance measurement process which is a distance measurement process using a plurality of sensor units 27. In the first distance measurement process, the relative position of the vehicle 2 and the communication terminal 21 is determined based on a plurality of distances d acquired by the wireless communication between each of the plurality of sensor units 27 and the communication terminal 21. The first distance measurement may be, preferably performed, for example, by a triangulation distance measurement. In the case of the triangulation distance measurement, the distance d between each of the multiple sensor units 27 and the communication terminal 21 is calculated, and the relative position between the vehicle 2 and the communication terminal 21 is calculated based on a combination of these distances d. It may be preferable that the first distance measurement process has a higher reliability of position detection than the second distance measurement process.

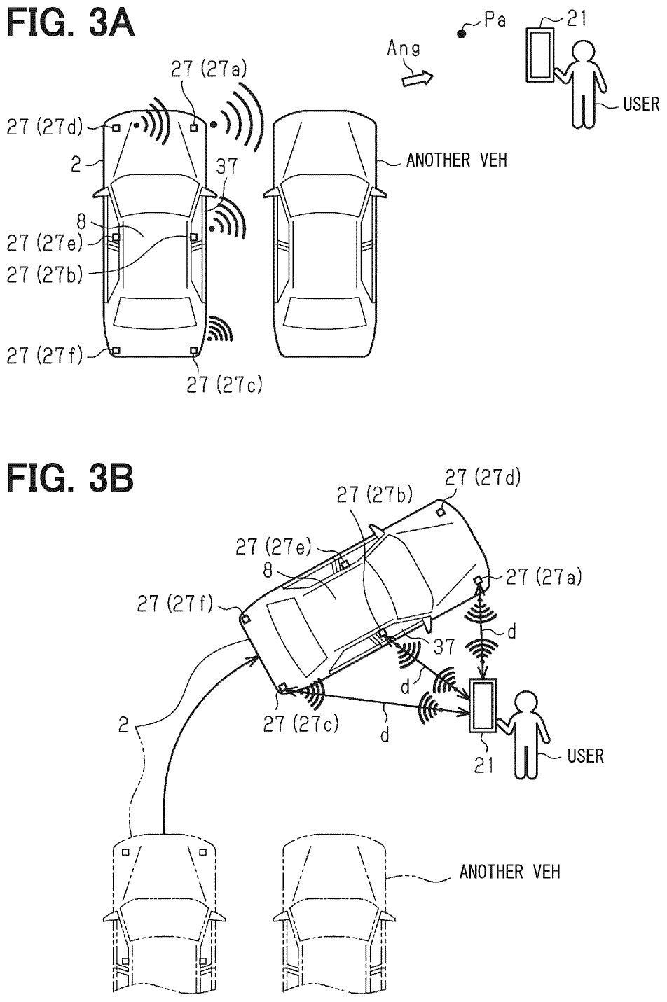

As shown in FIGS. 3A and 3B, the detection process includes a direction detection process for acquiring the direction Ang of the communication terminal 21 relative to the vehicle 2 by the wireless communication and determining the relative position between the vehicle 2 and the communication terminal 21. Here, there is a possibility that the position detection unit 26 may not be able to perform the distance measurement (i.e., the triangulation distance measurement) due to the influence of obstacles such as parked vehicles in the periphery of the vehicle. In this case, if the distance measurement is not possible but radio waves can be received, the relative position is determined using the direction detection process that detects the direction Ang of the communication terminal 21 from the radio waves. In the direction detection process, the direction Ang is acquired based on, for example, a reception signal strength indicator (i.e., RSSI or Received Signal Strength Indicator) of radio waves communicated between the communication terminal 21 and the sensor unit 27, an angle measurement (i.e., AoA or Angle of Arrival), or the like. It may be preferable that the distance measurement detection process has a higher reliability in the position detection than the direction detection process.

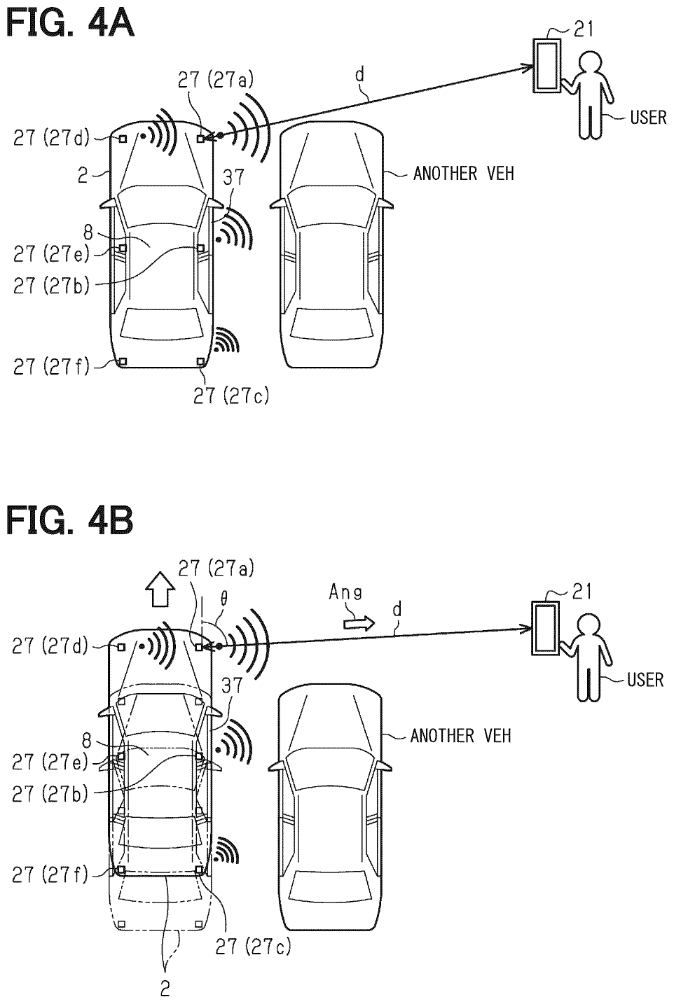

As shown in FIGS. 4A and 4B, the detection process includes a second distance measurement process that determines the relative position using a distance d between one sensor unit 27 and the communication terminal 21. The second distance measurement process determines the relative position between the vehicle 2 and the communication terminal 21 using a change in the distance d acquired by the wireless communication between one sensor unit 27 and the communication terminal 21.

Here, if the radio wave environment of the periphery of the vehicle is not excellent, there is a possibility that the first distance measurement process (i.e, the triangulation distance measurement) cannot be performed. At this time, if the distance measurement is possible with at least one sensor unit 27, the result of the distance measurement is used to calculate the relative position between the vehicle 2 and the communication terminal 21. In this example, in the second distance measurement process, the angle θ of vehicle 2 is estimated based on the change in the distance d, the vehicle speed of the vehicle 2, and the steering direction of vehicle 2, and also estimates the direction Ang of the communication terminal 21 when measuring from vehicle 2 based on the received signal intensity (i.e., RSSI) of audio waves including other sensor units 27. Then, the relative position between the vehicle 2 and the communication terminal 21 is determined based on the combination of the angle θ and the direction Ang.

As shown in FIG. 1, when the position detection unit 26 determines a relative position in the first distance measurement process or the second distance measurement process, the position detection unit 26 outputs distance measurement information Da to the controller 11. Then, the out-of-parking target calculation unit 28 calculates the out-of-parking target position Pa based on this distance measurement information Da. Furthermore, when the position detection unit 26 determines a relative position in the direction detection process, the position detection unit 26 outputs direction information Db to the controller 11. Then, the out-of-parking target calculation unit 28 calculates the out-of-parking target position Pa based on this direction information Da.

### (Other Configuration Elements of the Automatic System 20 for Getting Out of a Parking Area)

As shown in FIG. 1, the automatic system 20 for getting out of a parking area includes a state management unit 31 that sets the start and the stop of automatic getting out of a parking areal based on a user operation. The state management unit 31 is provided in the controller 11. The user operation may be preferably an operation executed on the user input unit 24 of the communication terminal 21, for example. When the state management unit 31 determines based on the vehicle periphery information Sa that the vehicle 2 is in a state in which the vehicle 2 cannot get out of the parking area, the state management unit 31 terminates the vehicle 2 from getting out of the parking area.

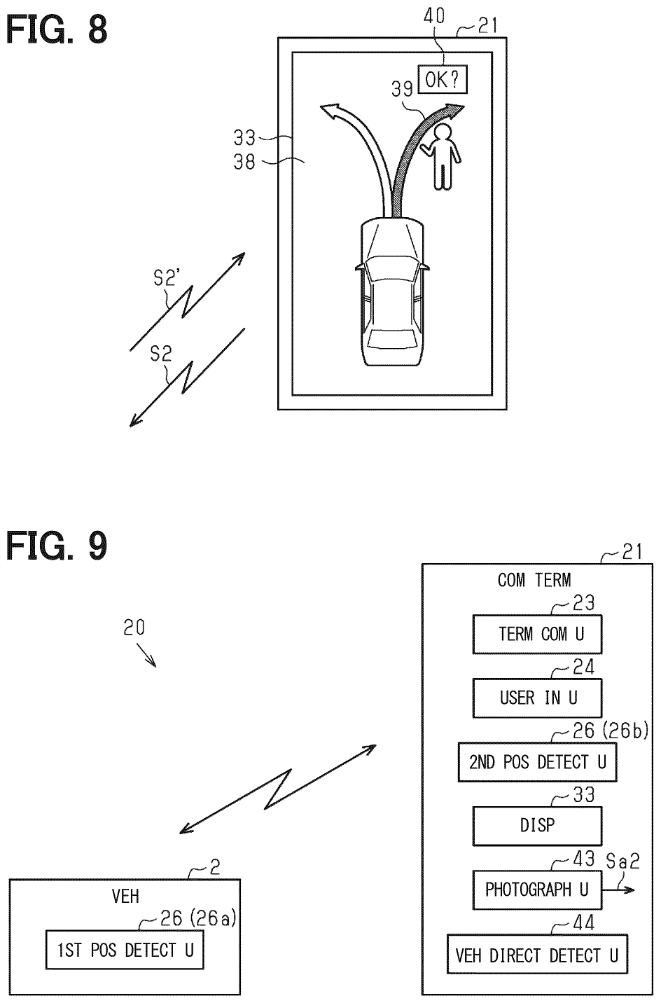

The automatic system 20 for getting out of a parking area is equipped with a validity check unit 32 that requires the user to check the validity of the out-of-parking target position Pa at the start of getting out of the parking area. The validity check unit 32 is provided in the controller 11. When the vehicle 2 starts getting out of the parking area, the validity check unit 32 transmits information of automatic getting out of the parking area (i.e., check information S2′ shown in FIG. 8) from the vehicle 2 to the communication terminal 21, thereby displaying the out-of-parking position or the out-of-parking direction on the display 33 of the communication terminal 21 and requiring the user to check the validity of the out-of-parking target position Pa. When the state management unit 31 confirms the validity of the out-of-parking target position Pa, the state management unit 31 permits the vehicle 2 to get out of a parking area.

Next, the operation of the automatic system 20 for getting out of a parking area (using a automatic method for getting out of a parking area) of this embodiment will be described.

### (Digital Key Setting of Communication Terminal 21)

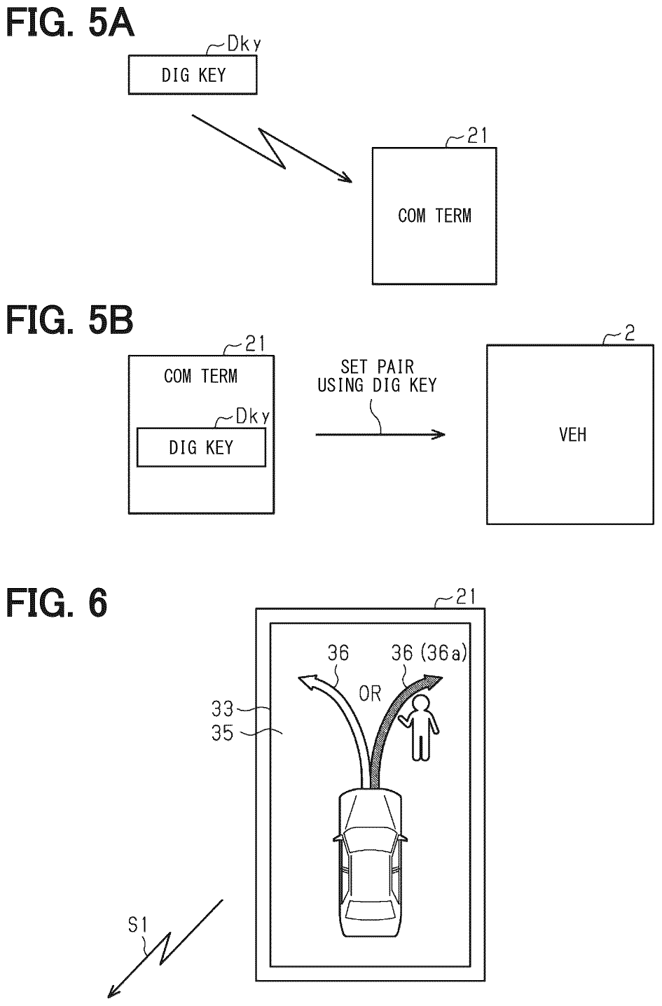

As shown in FIG. 5A, when enabling the automatic getting out of a parking area by the communication terminal 21, a digital key Dky for enabling the communication terminal 21 to be operated as a vehicle key is registered in the communication terminal 21 from outside. The digital key Dky is, for example, a one-time key for which a usage period and the number of times of use are set. The digital key Dky is generated as a vehicle-specific key, for example, at the request of a user. The digital key Dky is downloaded to the communication terminal 21 from a server, for example. It may be preferable that an application for automatic getting out of a parking area is also registered in the communication terminal 21 together with the digital key Dky.

As shown in FIG. 5B, after the communication terminal 21 acquires the digital key Dky, pairing setting is performed between the communication terminal 21 and the vehicle 2. Specifically, the communication terminal 21 transmits the digital key Dky to the vehicle 2 via the terminal communication unit 23. When the controller 11 receives the digital key Dky by the vehicle communication unit 22, the controller 11 authenticates the digital key Dky and acquires an authentication key common to the communication terminal 21. As a result, the vehicle 2 and the communication terminal 21 are paired, and thereafter, the wireless communication between the paired vehicle 2 and the communication terminal 21 becomes possible.

The digital key Dky may be a key that is authenticated when obtaining the permission to lock and unlock the doors of the vehicle 2. Therefore, if a person has the communication terminal 21 to which the digital key Dky is registered, the person can unlock the doors of the vehicle 2 to get in, or get off the vehicle 2 and lock the doors of the vehicle 2. The digital key Dky may be a key that is authenticated when obtaining the permission to perform a transition operation of the power supply of the vehicle 2. Therefore, if a person has the communication terminal 21 to which the digital key Dky is registered, the person can start the engine of the vehicle 2.

### (Procedure for Automatically Getting Out of a Parking Area)

As shown in FIG. 6, the user uses the communication terminal 21 to perform an operation for preparing for automatically getting out of a parking area. Specifically, the communication terminal 21 activates the application for automatically getting out of a parking area to display a screen 35 of a preparation for automatically getting out of a parking area, and the user designates the out-of-parking direction of the vehicle 2 on the screen 35 of a preparation for automatically getting out of a parking area. In the case of this drawing, an arrow 36 indicating the out-of-parking direction is displayed on the screen 35 of a preparation for automatically getting out of a parking area. Then, the user executes the operation of a preparation for automatically getting out of a parking area by tapping the arrow 36 in the desired out-of-parking direction. Here, it is assumed that the arrow 36a toward the user direction is tapped. When the operation of a preparation for automatically getting out of a parking area is executed, the communication terminal 21 transmits a notification S1 of a preparation to start automatically getting out of a parking area from the terminal communication unit 23 to the vehicle 2 via the wireless communication.

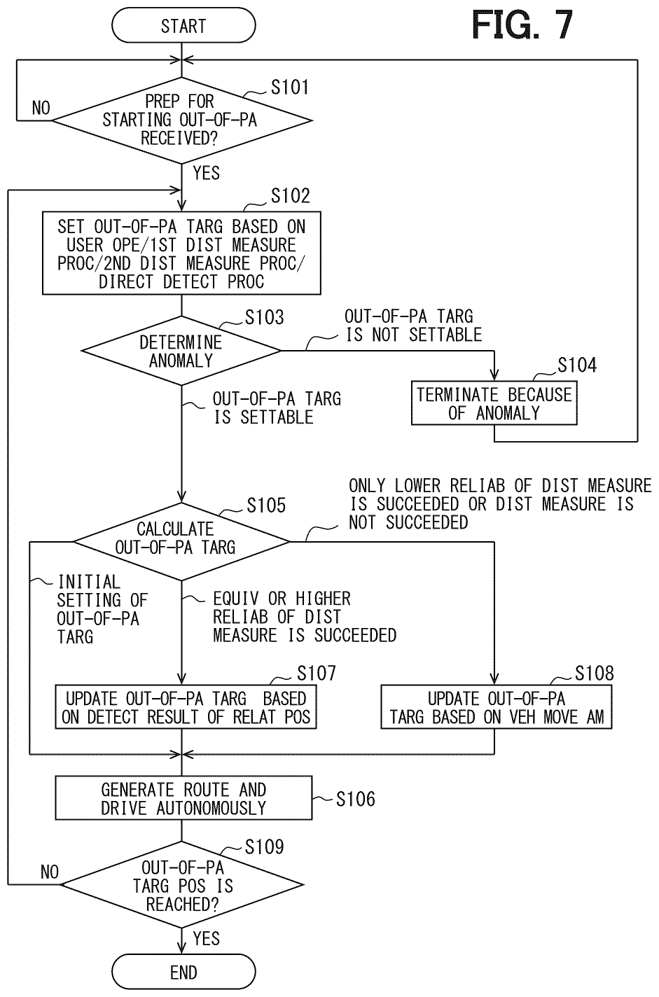

As shown in FIG. 7, in step S101, the state management unit 31 determines whether or not a preparation for starting automatically getting out of a parking area (i.e., the notification S1 of a preparation to start automatically getting out of a parking area) has been received. In this example, the state management unit 31 determines whether the vehicle communication unit 22 has received the notification S1 of a preparation to start automatically getting out of a parking area transmitted from the communication terminal 21. If the notification S1 of a preparation to start automatically getting out of a parking area has been received, the process proceeds to step S102, and if the notification S1 of a preparation to start automatically getting out of a parking area has not been received, the process waits in step S101.

In step S102, the out-of-parking target calculation unit 28 executes setting of the out-of-parking target position Pa by calculation. First, the position detection unit 26 determines the relative position between the communication terminal 21 and the sensor unit 27 via the wireless communication between the communication terminal 21 and the sensor unit 27, and outputs the detection result to the controller 11. In this example, the position detection unit 26 executes three detection processes of: a “first distance measurement process”, a “second distance measurement process”, and a “direction detection process”. In the first distance measurement process and the second distance measurement process, the position detection unit 26 outputs the measurement distance information Da to the controller 11. Furthermore, in the case of the direction detection process, the position detection unit 26 outputs the acquired direction information Db to the controller 11.

The out-of-parking target calculation unit 28 calculates the out-of-parking target position Pa in each of the first distance measurement process, the second distance measurement process, and the direction detection process. The out-of-parking target positions Pa in the first distance measurement process and the second distance measurement process are acquired from the distance measurement information Da acquired from the position detection unit 26. The out-of-parking target position Pa in the direction detection process is acquired from the direction information Db acquired from the position detection unit 26.

As shown in FIG. 2A, in the first distance measurement process, the position detection unit 26 measures the relative position of the communication terminal 21 by the triangulation distance measurement. The distance measurement method may be preferably a ToF (i.e., Time of Flight) method, which calculates the distance d from the difference between the transmission time, which is the time when a radio wave is transmitted, and the reception time, which is the time when the reflected wave of the radio wave is received. The distance measurement can be performed by any one of the sensor units 27 that has a received signal intensity of a radio wave being communicated that is equal to or greater than a predetermined value. In the example shown in the drawing, the distance measurement is possible using the right front sensor unit 27a to the right rear sensor unit 27c.

The out-of-parking target calculation unit 28 calculates the out-of-parking target position Pa based on the distance measurement information Da acquired by the first distance measurement process, i.e., the triangulation distance measurement. The periphery state of the vehicle 2 may be monitored by the detection unit 3, and the out-of-parking target position Pa may also be set using the vehicle periphery information Sa acquired from the detection unit 3.

The out-of-parking target position Pa is usually set at a position such that the driver's door 37 of the vehicle 2 is disposed in front of the user. Here, there may be cases where the distance between the user and an obstacle on the opposite side is narrow, or the road width is narrow, so that it is not possible to get out of a parking area such that the driver's door 37 of the vehicle 2 is disposed in front of the user. Therefore, when the out-of-parking target calculation unit 28 determines, based on the vehicle periphery information Sa, that it is not possible to set the out-of-parking target position Pa such that the driver's door 37 of the vehicle 2 is disposed in front of the user, the out-of-parking target calculation unit 28 may set the out-of-parking target position Pa such that a door of the vehicle other than the driver's door 37 is disposed in front of the user.

As shown in FIG. 3A, in the case of the direction detection process, the position detection unit 26 detects the direction Ang of the user when measuring from the vehicle 2 by, for example, measuring the received signal intensity of radio waves or an angle of radio waves. In the case of the same drawing, an example is shown in which the communication terminal 21 is able to receive radio waves from the right front sensor unit 27a to the left front sensor unit 27d among the multiple sensor units 27, but is unable to receive radio waves from the left center sensor unit 27e and the left rear sensor unit 27f. In addition, in the same drawing, an example is shown in which the radio waves from the right front sensor unit 27a have the strongest received signal intensity, the radio waves from the right center sensor unit 27b and the left front sensor unit 27d have the second strongest received signal intensity, and the radio waves from the right rear sensor unit 27c have the weakest received signal intensity.

The out-of-parking target calculation unit 28 calculates a out-of-parking target position Pa based on the direction information Db acquired by the direction detection process. At this point in time, the position of the communication terminal 21 has not been specified, but the direction Ang in which the communication terminal 21 is estimated to be disposed is set as the initial target out-of-parking position Pa.

As shown in FIGS. 4A and 4B, the position detection unit 26 cannot perform the triangulation distance measurement but can perform the second distance measurement process if at least one sensor unit 27 can detect a distance. In the example shown in the drawing, the distance measurement is performed only by the radio waves from the right front sensor unit 27a. Here, since the second measurement process requires a change in the measured distance d in detecting the relative position, the position detection is not performed when the initial out-of-parking target is set.

As shown in FIG. 7, after the out-of-parking target position Pa is set in step S103, the state management unit 31 determines whether or not there is an anomaly in the periphery environment of the parking area. Specifically, the state management unit 31 determines whether or not there is an obstacle in the direction of travelling of the vehicle 2 based on the vehicle periphery information Sa input from the detection unit 3. In addition, the state management unit 31 determines whether or not the distance measurement suddenly becomes impossible although the distance measurement having been possible up until that point. If the anomaly is determined, the process proceeds to step S104, and if the anomaly is not determined, the process proceeds to step S105.

In step 104, if the anomaly is detected, the state management unit 31 terminates the automatic getting out of the parking area of the vehicle 2 due to the anomaly. Thus, the operation of the automatic getting out of the parking area is forcibly terminated. After the forced termination, the process returns to step S101, and the above-described processes are executed again.

In step S105, the out-of-parking target calculation unit 28 calculates the final out-of-parking target position Pa. It may be preferable that this out-of-parking target position Pa is set using the result of a process having the highest reliability of position accuracy among the first distance measurement process, the second distance measurement process, and the direction detection process. In this example, in general, the reliability of the position detection increases in the order of the first distance measurement process, the second distance measurement process, and the direction detection process. Therefore, the out-of-parking target position Pa calculated by the detection process with the highest reliability among the detection processes that have been performed is set as the final out-of-parking target position Pa. It may be preferable that the out-of-parking target calculation unit 28 also uses the photograph information Sa1 to determine the relative position. In other words, the out-of-parking target position Pa may be set taking into consideration the periphery environment of the vehicle 2.

As shown in FIG. 8, when the initial out-of-parking target position Pa is set, the validity check unit 32 requires the user to check the validity of the out-of-parking target position Pa. In this example, when starting the getting out of a parking area, the validity check unit 32 controls the display 33 of the communication terminal 21 to display a confirmation screen 38 by transmitting the information of the automatic getting out of the parking area (i.e., check information S2′) from the vehicle 2 to the communication terminal 21. In this drawing, an arrow 39 indicating the direction of getting out of a parking area is displayed on the confirmation screen 38. If the direction of getting out of a parking area is proper, the determination button 40 on the confirmation screen 38 is tapped. When the communication terminal 21 confirms the direction of getting out of a parking area, the communication terminal 21 transmits a out-of-parking permission S2 from the terminal communication unit 23 to the vehicle 2 via the wireless communication. Therefore, by acquiring the out-of-parking permission S2, the vehicle 2 is permitted to perform the automatic getting out of a parking area.

As shown in FIG. 7, in step S105, when the initial out-of-parking target position Pa is set, the process proceeds to step S106. Also, in step S105, when the second or subsequent out-of-parking target calculation is performed, if the distance measurement is succeeded using a detection process with the equivalent reliability, or if the distance measurement is succeeded using a detection process with a higher reliability than the current one, the process proceeds to step S107. On the other hand, in step S105, when the second or subsequent out-of-parking target calculation is performed, if the distance measurement is succeeded only in a detection process with a lower reliability than the current one, or if the distance measurement itself is not succeeded, the process proceeds to step S108.

In step S106, after the out-of-parking target position Pa is set, the vehicle control unit 17 generates a route for getting out of the parking area with the out-of-parking target position Pa as the end point, and causes the vehicle 2 to autonomously drive along the route for getting out of the parking area. That is, the vehicle control unit 17 automatically drives the vehicle 2 toward the out-of-parking target position Pa.

In step S107, the out-of-parking target calculation unit 28 updates the out-of-parking target position Pa based on the detection result of the relative position when performing the out-of-parking target calculation for the second or subsequent times. In this example, when the distance measurement is succeeded using a detection process with the equivalent reliability during the getting out of a parking area, or when the distance measurement is succeeded using a detection process with the higher reliability than the current reliability during the getting out of a parking area, the out-of-parking target calculation unit 28 updates the out-of-parking target position based on the detection result (i.e., the relative position detection result) of the position detection unit 26. For example, if the previous time was succeeded by the first distance measurement process and the current time is succeeded by the second distance measurement process, the out-of-parking target position Pa is set by the first distance measurement process in the same way as the previous time. In addition, if the previous process was succeeded by the direction detection process and the current process is succeeded by the first distance measurement process, the out-of-parking target position Pa is updated by the first distance measurement process.

Here, it may be preferable that the out-of-parking target calculation unit 28 determines the reliability of the detection process based on the number of sensor units 27 that establish the communication with the communication terminal 21. Specifically, for example, when the out-of-parking target position Pa is set by the same first distance measurement process both the previous time and the current time, the out-of-parking target calculation unit 28 determines the one of the previous time and the current time at which the number of sensor units 27 used in the triangulation distance measurement is larger as the higher reliability of the detection process. The same applies to the second distance measurement process and the direction detection process.

In addition, it may be preferable that the out-of-parking target calculation unit 28 determines the reliability of the detection process based on the received signal intensity of the radio waves communicated between the communication terminal 21 and the sensor unit 27. Specifically, for example, when the out-of-parking target position Pa is set by the same first distance measurement process both the previous time and the current time, the out-of-parking target calculation unit 28 determines the out-of-parking target calculation unit 28 determine the one of the previous time and the current time at which the received signal intensity of the radio waves is higher as the higher reliability of the detection process. The same applies to the second distance measurement process and the direction detection process.

In step S108, the out-of-parking target calculation unit 28 executes updating of the out-of-parking target position Pa based on the vehicle travel amount when calculating the out-of-parking target position for the second or subsequent times. In this example, when setting the out-of-parking target for the second or subsequent times, if the distance measurement is only succeeded in a detection process with a lower reliability than the current reliability, or if the distance measurement itself is not succeeded, the out-of-parking target calculation unit 28 updates the out-of-parking target position Pa based on the vehicle travel amount. The vehicle travel amount is, for example, the travel amount of the vehicle during one cycle of update determination, and is calculated from the vehicle speed and the steering amount. In this way, when the distance measurement and the direction detection are not possible, the target distance is reduced in proportion to the approach to the out-of-parking target position Pa. Here, if the detection results of the detection process are clearly different, the automatic getting out of a parking area may be forcibly terminated.

As shown in FIGS. 2A and 2B, when there are no other parked vehicles or obstacles around the vehicle 2 as an out-of-parking object, the position detection unit 26 of the vehicle 2 and the communication terminal 21 can perform the wireless communication stably. Therefore, the relative position between the vehicle 2 and the communication terminal 21 can be determined with high accuracy by the first distance measurement process (i.e., the triangulation distance measurement). Therefore, when the vehicle 2 automatically gets out of a parking area, it is possible to get out of a parking area as close to the user location as possible with high accuracy.

As shown in FIGS. 3A and 3B, if there are other parked vehicles or obstacles around the vehicle 2 as an out-of-parking object, and the position detection unit 26 of the vehicle 2 can not perform the distance measurement together with the communication terminal 21, and when the vehicle starts to get out of a parking area, the approximate relative position of the communication terminal 21 is determined by a direction detection process (using the received signal strength indicator (i.e., the RSSI) or the angle measurement (using the AoA) and the like) to cause the vehicle to get out of the parking area. Then, if the communication state improves after starting to get out of the parking area, and the wireless communication for the distance measurement (e.g., the first distance measurement process and the second distance measurement process) becomes possible, the vehicle continues getting out of a parking area according to the out-of-parking target position Pa that is set based on the distance measurement result.

As shown in FIGS. 4A and 4B, when the triangulation distance measurement is not possible but the distance measurement is possible using at least one sensor unit 27, first, the out-of-parking target position Pa is set by direction detection process, and the vehicle 2 starts to get out of a parking area. That is, even if the distance measurement is possible using one sensor unit 27, but the triangulation distance measurement cannot be performed, the initial out-of-parking target position Pa is determined by the direction detection process, and the vehicle 2 starts to get out of a parking area.

When the vehicle is travelling, the second distance measurement process using at least one sensor unit 27 is intermittently performed to acquire a change in the distance d between the communication terminal 21 and the sensor unit 27. At this time, the angle θ of the user with respect to the vehicle 2 is calculated from the change in the distance d calculated using at least one sensor unit 27 and the changes in the vehicle speed and the steering direction. Also, the direction Ang of the communication terminal 21 is calculated based on the received signal intensity of the radio waves including those of the other sensor units 27. Then, the relative position between the vehicle 2 and the communication terminal 21 is determined based on the combination of the angle θ and the direction Ang.

After the vehicle continues getting out of a parking area, if the communication state of the periphery improves, the first distance measurement process (i.e., the triangulation distance measurement) becomes possible. Until then, the out-of-parking target position Pa is determined by the second distance measurement process, and the getting out of a parking area with respect to the vehicle 2 is performed, and when the first distance measurement process (i.e., the triangulation distance measurement) becomes possible, the vehicle continues getting out of a parking area toward the out-of-parking target position Pa determined by the first distance measurement process (i.e., the triangulation distance measurement).

In step S109, the state management unit 31 determines whether the vehicle 2 has reached the out-of-parking target position Pa. If the vehicle 2 has not reached the out-of-parking target position Pa, the process returns to step S102 and the process for automatically getting out of a parking area continues. On the other hand, if the vehicle 2 has reached the out-of-parking target position Pa, the process ends.

### Effects of Embodiment

According to the automatic system 20 for getting out of a parking area (i.e., the automatic method for getting out of a parking area) of the above embodiment, the following effects can be obtained.

(1-1) When an request Sb for getting out of a parking area with respect to the parked vehicle 2 is received, the automatic system 20 for getting out of a parking area causes the vehicle to automatically get out of a parking area toward the location of the user. The automatic system 20 for getting out of a parking area includes a vehicle control unit 17, a position detection unit 26, and a out-of-parking target calculation unit 28. The position detection unit 26 detects a relative position between a communication terminal 21 carried by the user and the vehicle 2 according to any one of a plurality of detection processes corresponding to a communication state among the plurality of detection processes using a wireless communication between the communication terminal 21 and one or more sensor units 27 mounted on a vehicle body 8. The out-of-parking target calculation unit 28 sets a out-of-parking target position Pa based on the detection result of the position detection unit 26. During the getting out of a parking area, when the position detection can be performed by a detection process with a higher reliability than the currently set out-of-parking target position Pa, the out-of-parking target calculation unit 28 updates the out-of-parking target position Pa based on the detection result, and calculates an optimal out-of-parking target position Pa. The vehicle control unit 17 controls the automatic driving of the vehicle 2 so that the vehicle 2 reaches the out-of-parking target position Pa.

According to the present embodiment, the position relationship between the vehicle 2 as an out-of-parking object and the communication terminal 21 is acquired according to a relative position, and the out-of-parking target position Pa when automatically getting out of the parking area is calculated based on the relative position. Therefore, even if the vehicle 2 is parked inside a building, it is possible to automatically get out of the parking area. Further, the out-of-parking target position Pa as a driving target position of the vehicle 2 when automatically getting out of the parking area is updated, so that the optimum out-of-parking target position Pa is set each time. Thus, the out-of-parking target position Pa is optimized. As a result, it is possible to improve the accuracy of arrival at a location intended by a user when automatically getting out of a parking area.

(1-2) The detection process includes the distance measurement detection process and the direction detection process. In the distance measurement detection process, the distance d between the communication terminal 21 and the sensor unit 27 is acquired by the wireless communication, and the relative position between the vehicle 2 and the communication terminal 21 is determined. In the direction detection process, the direction Ang of the communication terminal 21 relative to the vehicle 2 is acquired by the wireless communication, and the relative position between the vehicle 2 and the communication terminal 21 is determined.

According to this configuration, when the communication environment allows the distance measurement, it is possible to use the first distance measurement process to determine the out-of-parking target position Pa with high accuracy. In addition, in a communication environment where the distance measurement is not possible, a direction detection process is used to determine a rough out-of-parking target position Pa, and the vehicle 2 automatically gets out of the parking area. Therefore, the out-of-parking target position Pa can be set by an appropriate detection process according to the communication environment at each time.

(1-3) The distance measurement detection process includes a first distance measurement process and a second distance measurement process. In the first distance measurement process, the relative position of the vehicle 2 and the communication terminal 21 is determined based on a plurality of distances d acquired by the wireless communication between each of the plurality of sensor units 27 and the communication terminal 21. The second distance measurement process determines the relative position between the vehicle 2 and the communication terminal 21 using a change in the distance d acquired by the wireless communication between one sensor unit 27 and the communication terminal 21.

According to this configuration, when the multiple sensor units 27 are capable of communicating with the communication terminal 21, it is possible to determine the out-of-parking target position Pa with high accuracy using the first distance measurement process. In addition, when the first distance measurement process cannot be performed but the wireless communication with the communication terminal 21 is possible using only one sensor unit 27, it is possible to acquire the out-of-parking target position Pa using the second distance measurement process. Therefore, the out-of-parking target position Pa can be set by an appropriate distance measurement detection process according to the communication environment at each time.

(1-4) The out-of-parking target calculation unit 28 identifies the reliability of the detection process based on the number of sensor units 27 that establish communication with the communication terminal 21. According to this configuration, it is possible to set the out-of-parking target position Pa by prioritizing the detection result of the detection process in which the number of sensor units 27 that establish communication with the communication terminal 21 is large. This further contributes to improving the accuracy of arrival at a location intended by a user when automatically getting out of a parking area.

(1-5) The out-of-parking target calculation unit 28 identifies the reliability of the detection process based on the received signal intensity of the radio waves communicated between the communication terminal 21 and the sensor unit 27. According to this configuration, it is possible to set the out-of-parking target position Pa by prioritizing the detection result of the detection process executed using radio waves with high received signal intensity. This further contributes to improving the accuracy of arrival at a location intended by a user when automatically getting out of a parking area.

(1-6) During getting out of the parking area, when the distance measurement is succeeded using a detection process with the equivalent reliability, or when the distance measurement is succeeded using a detection process with a higher reliability than the current reliability, the out-of-parking target calculation unit 28 updates the out-of-parking target position Pa based on the distance measurement information Da acquired from the position detection unit 26. According to this configuration, since it is possible to automatically get out of the parking area with respect to the vehicle 2 based on a more reliable detection process, so that this feature further contributes to improving the accuracy of arrival at a location intended by a user when automatically getting out of a parking area.

(1-7) During getting out of the parking area, if the distance measurement is only succeeded in a detection process with a lower reliability than the current reliability, or if the distance measurement itself is not succeeded, the out-of-parking target calculation unit 28 updates the out-of-parking target position Pa based on the amount of travel of the vehicle. According to this configuration, when the vehicle is automatically getting out of the parking area using the detection process with the high reliability, if the communication environment suddenly deteriorates and the detection process with the high reliability can not be performed, it is possible to reduce the distance to the target position by the amount of travel of the vehicle 2 during one cycle of the update determination process. In this way, even if the detection process with the high reliability cannot be performed in the middle of the process, it is possible to update the distance in proportion to the approach to the out-of-parking target position Pa. Thus, it is possible to avoid the forcible termination in the middle of the automatic getting out of the parking area.

(1-8) The automatic system 20 for getting out of a parking area includes an information acquisition unit 16 that acquires vehicle periphery information Sa from a detection unit 3 provided in the vehicle 2 to acquire the situation around the vehicle. According to this configuration, the vehicle periphery information Sa input from the detection unit 3 can be used to manage the operation of automatic getting out of the parking area and to calculate the out-of-parking target position Pa.

(1-9) When the state management unit 31 of the automatic system 20 for getting out of a parking area determines based on the vehicle periphery information Sa that the vehicle is in a state in which the getting out of the parking area cannot be performed, the state management unit 31 stops getting out of a parking with respect to the vehicle 2. According to this configuration, since the automatic getting out of the parking area for the vehicle 2 starts in a state where the safety around the vehicle has been confirmed, this feature further contributes to improving the safety when automatically getting out of a parking area.

(1-10) The detection unit 3 includes an all around camera 4 that captures images of the periphery of the vehicle 2. The vehicle periphery information Sa includes the photograph information Sa1 photographed by the all around camera 4. The out-of-parking target calculation unit 28 determines the out-of-parking target position Pa by using the photograph information Sa1 in addition. According to this configuration, the out-of-parking target position Pa is determined by also utilizing the photograph information Sa1 of the all around camera 4, so that the calculation accuracy of the out-of-parking target position Pa can be improved. This feature further contributes to improving the accuracy of automatic getting out of the parking area.

(1-11) The out-of-parking target position Pa is usually set at a position such that the driver's door 37 of the vehicle 2 is disposed in front of the user. Therefore, when the out-of-parking target calculation unit 28 determines, based on the vehicle periphery information Sa, that it is not possible to set the out-of-parking target position Pa such that the driver's door 37 of the vehicle 2 is disposed in front of the user, the out-of-parking target calculation unit 28 may set the out-of-parking target position Pa such that a door of the vehicle other than the driver's door 37 is disposed in front of the user. According to this configuration, the vehicle 2 can automatically get out of the parking area toward an appropriate position according to the user's periphery situation.

(1-12) When the vehicle 2 starts getting out of the parking area, the validity check unit 32 of the automatic system 20 for getting out of a parking transmits information of automatic getting out of the parking area from the vehicle 2 to the communication terminal 21, thereby displaying the out-of-parking position or the out-of-parking direction on the display 33 of the communication terminal 21 and requiring the user to check the validity of the out-of-parking target position Pa. This configuration further contributes to improving the accuracy of arrival at a location intended by a user when automatically getting out of a parking area.

### Second Embodiment

Next, a second embodiment will be described. The second embodiment is an example in which a method for trouble shooting in a case where the distance measurement or the direction detection is not possible in the first embodiment is added. Therefore, the same parts as those in the first embodiment are denoted by the same reference numerals and their explanation is omitted, and only the different parts will be described in detail.

### Main Configuration of the Second Embodiment

As shown in FIG. 9, the position detection unit 26 includes a first position detection unit 26a provided in the vehicle 2 and a second position detection unit 26b provided in the communication terminal 21. The first position detection unit 26a is the position detection unit 26 described in the first embodiment, and executes the same processing as the position detection unit 26.

When the first position detection unit 26a is unable to detect the position, the second position detection unit 26b detects the relative position between the vehicle 2 and the communication terminal 21 based on the photograph information Sa2 of the vehicle 2 photographed by the photograph unit 43 provided in the communication terminal 21. This is a measure to enable the vehicle 2 to automatically get out of the parking area even when a situation arises in which it is not possible to perform all of the first distance measurement process, the second distance measurement process, and the direction detection process. The photograph unit 43 is, for example, a camera of the communication terminal 21. The photograph information Sa2 may be either a still image or a moving image. The second position detection unit 26 b transmits information on the detected relative position from the terminal communication unit 23 to the vehicle 2.

The out-of-parking target calculation unit 28 calculates a out-of-parking target position Pa based on the relative position acquired from the photograph information Sa2. In this example, the out-of-parking target calculation unit 28 receives the information about the relative position transmitted from the communication terminal 21 by the vehicle communication unit 22, and calculates the out-of-parking target position Pa based on this information. The vehicle control unit 17 starts automatically getting out of the parking area toward this out-of-parking target position Pa.

The communication terminal 21 includes a vehicle direction detection unit 44 that monitors the traveling direction of the vehicle 2 when the vehicle 2 is getting out of the parking area toward the out-of-parking target position Pa set based on the photograph information Sa2. While the vehicle 2 is getting out of the parking area, the vehicle direction detection unit 44 monitors the traveling direction of the vehicle 2 based on the moving image as the photograph information Sa2, and wirelessly transmits information on the traveling direction of the vehicle 2 from the terminal communication unit 23 to the vehicle 2. The vehicle control unit 17 receives the information on the traveling direction of the vehicle 2 by the vehicle communication unit 22, and acquires the traveling direction of the vehicle 2 recognized by the communication terminal 21. The vehicle control unit 17 forcibly terminates the automatic getting out of the parking area with respect to the vehicle 2 when the detection result of the vehicle direction detection unit 44 is different from the traveling direction of the vehicle itself.

### (Operation)

Next, the operation of the automatic system 20 for getting out of a parking area (using a automatic method for getting out of a parking area) of this embodiment will be described.

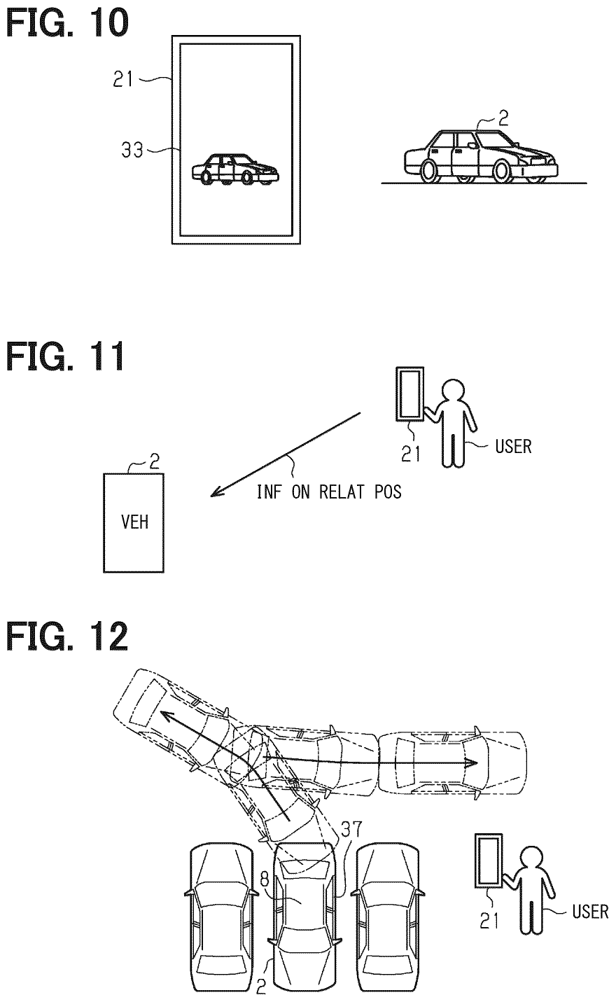

As shown in FIG. 10, when the vehicle 2 is automatically getting out of a parking area, if all of processes of the first distance measurement process, the second distance measurement process, and the direction detection process cannot all be performed, the user photographs the vehicle 2 by pointing the communication terminal 21. The second position detection unit 26b calculates the relative position of the communication terminal 21 with respect to the vehicle 2 based on the photograph information Sa2 acquired by the photograph unit 43 of the communication terminal 21. The relative position is specified, for example, from the size and the orientation of the vehicle 2 shown on the display 33. Alternatively, the vehicle itself may be specified based on the shape of the vehicle 2 or the illumination of its turn signals.

As shown in FIG. 11, the second position detection unit 26b transmits the information on the detected relative position from the terminal communication unit 23 to the vehicle 2. It may be preferable that the information on the relative position is transmitted from the communication terminal 21 to the vehicle 2 when, for example, an operation for transmitting information is executed on the communication terminal 21. The out-of-parking target calculation unit 28 calculates a out-of-parking target position Pa based on the relative position information acquired from the communication terminal 21. Then, the vehicle control unit 17 starts automatically getting out of the parking area with respect to the vehicle 2 toward the out-of-parking target position Pa.

Here, the feature in the embodiment may not be limited to the transmitting of the relative position information from the communication terminal 21 to the vehicle 2 and the calculating of the out-of-parking target position Pa in the vehicle 2. For example, the communication terminal 21 may calculate the out-of-parking target position Pa, and transmit the information on the out-of-parking target position Pa from the communication terminal 21 to the vehicle 2. Then, based on the information on the out-of-parking target position Pa, the automatic getting out of the parking area with respect to the vehicle 2 may be started.

The vehicle direction detection unit 44 receives the moving image as the photographic information Sa2 from the photograph unit 43 for a certain period of time after the vehicle starts getting out of the parking area, and monitors the traveling direction of the vehicle 2 based on this photograph information Sa2. Then, the vehicle direction detection unit 44 wirelessly transmits the information on the traveling direction of the vehicle 2, which is the monitoring result, from the terminal communication unit 23 to the vehicle 2. The vehicle control unit 17 forcibly terminates the automatic getting out of the parking area with respect to the vehicle 2 when the detection result of the vehicle direction detection unit 44 is different from the traveling direction of the vehicle itself. At this time, it may be preferable that the vehicle control unit 17 notifies the communication terminal 21 via the wireless communication that the getting out of a parking area has been forcibly terminated.

When the vehicle 2 is getting out of a parking area toward the out-of-parking target position Pa set according to the photograph information Sa2, if the position detection by the first position detection unit 26a becomes possible, the out-of-parking target calculation unit 28 updates the out-of-parking target position Pa by also using the detection result of the first position detection unit 26a. That is, initially, the vehicle is getting out of a parking area toward the out-of-parking target position Pa that is set based on the photograph information Sa2 of the photograph unit 43 of the communication terminal 21, but when the communication is restored to a state where the distance measurement and the direction detection are possible, the vehicle may continue getting out of a parking area while updating the out-of-parking target position Pa through the distance measurement and the direction detection.

### Effects of Embodiment

According to the automatic system 20 for getting out of a parking area (i.e., the automatic method for getting out of a parking area) of the above embodiment, the following effects can be obtained.

(2-1) The position detection unit 26 includes a first position detection unit 26a provided in the vehicle 2 and a second position detection unit 26b provided in the communication terminal 21. When the first position detection unit 26a is unable to detect the position, the second position detection unit 26b detects the relative position between the vehicle 2 and the communication terminal 21 based on the photograph information Sa2 of the vehicle 2 photographed by the photograph unit 43 provided in the communication terminal 21. The out-of-parking target calculation unit 28 calculates a out-of-parking target position Pa based on the relative position acquired from the photograph information Sa2.

According to this configuration, even if the first position detection unit 26a cannot detect the position, the second position detection unit 26b of the communication terminal 21 can determine the relative position based on the photograph information Sa2 acquired by photographing the vehicle 2 with the communication terminal 21, and it is possible for the vehicle 2 to get out of a parking area. Therefore, even if the communication environment is not excellent and the distance measurement or the direction detection is not possible, it is possible for the vehicle 2 to get out of a parking area, so that the configuration further contributes to improving convenience for the user.

(2-2) The communication terminal 21 includes a vehicle direction detection unit 44 that monitors the traveling direction of the vehicle 2 when the vehicle 2 is getting out of the parking area toward the out-of-parking target position Pa set based on the photograph information Sa2. The vehicle control unit 17 forcibly terminates the automatic getting out of the parking area with respect to the vehicle 2 when the detection result of the vehicle direction detection unit 44 is different from the traveling direction of the vehicle itself. According to this configuration, even when the out-of-parking target position Pa is set based on the photograph information Sa2 acquired by the photograph unit 43 of the communication terminal 21 and the vehicle gets out of a parking area, safety at the time of getting out of a parking area can be ensured.

(2-3) When the vehicle 2 is getting out of a parking area toward the out-of-parking target position Pa set according to the photograph information Sa2, if the position detection by the first position detection unit 26a becomes possible, the out-of-parking target calculation unit 28 updates the out-of-parking target position Pa by also using the detection result of the first position detection unit 26a. According to this configuration, even if the vehicle 2 starts automatically getting out of a parking area based on the detection result of the second position detection unit 26b, the out-of-parking target position Pa is set after starting in view of the detection result of the first position detection unit 26a, which has high position detection accuracy, in addition. This configuration further contributes to improving the accuracy of arrival at a location intended by a user when automatically getting out of a parking area.

### (Modifications)

The above-described embodiment may be modified as follows. The above described embodiments and the following modifications can be implemented in combination with one another as long as there is no technical contradiction.

In each embodiment, the getting out of a parking area of the vehicle 2 is not limited to forward getting out of a parking area in which the vehicle 2 parked in reverse then moves forward toward the out-of-parking target position Pa, but also includes rear getting out of a parking area in which the vehicle 2 parked forward then moves backward to exit the parking space, and after that the vehicle moves forward toward the out-of-parking target position Pa, as shown in FIG. 12. According to this configuration, even if the vehicle 2 is parked by moving forward, the vehicle 2 can automatically get out of a parking area, so that the configuration further contributes to improving convenience for the user.

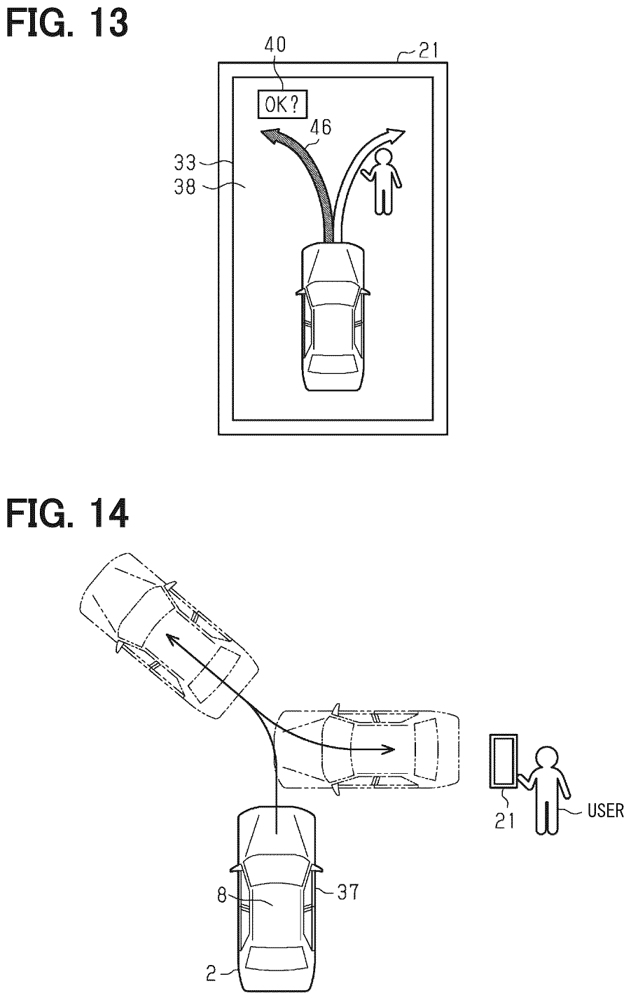

In each embodiment, as shown in FIGS. 13 and 14, when the out-of-parking direction selected by the user is opposite to the out-of-parking direction defined by the out-of-parking target position Pa, the getting out of a parking area may be performed so that the rear of the vehicle 2 is disposed in front of the user. In this case, as shown in FIG. 13, when the user requests the automatic getting out of a parking area so that the rear of the vehicle 2 is disposed in front of the user, for example, the user selects the arrow 46 indicating the out-of-parking direction opposite to the direction in which the user is located, and taps the determination button 40. This information is wirelessly transmitted from the communication terminal 21 to the vehicle 2.

As shown in FIG. 14, the vehicle control unit 17 starts getting out of a parking area based on the information acquired from the communication terminal 21 so that the rear of the vehicle 2 is disposed in front of the user. In other words, when the out-of-parking direction selected by the user is opposite to the out-of-parking direction defined by the out-of-parking target position Pa, the vehicle 2 gets out of a parking area so that the rear of the vehicle 2 is disposed in front of the user. According to this configuration, it is possible to perform when the user requests the automatic getting out of a parking area so that the rear of the vehicle 2 is disposed in front of the user, so that the configuration further contributes to improving convenience for the user.

In each embodiment, the out-of-parking request Sb may be transmitted to the vehicle 2 not from the communication terminal 21 but, for example, from a center. The center, for example, comprehensively manages the automatic getting out of a parking area, and may, for example, receive a out-of-parking request (i.e., the out-of-parking request Sb) from a user or notify the vehicle 2 of a out-of-parking instruction when a pre-set reserved time for getting out of a parking area arrives.

In each embodiment, the direction detection process may be set to have a higher reliability than the distance measurement process. This is because, for example, if the number of sensor units 27 is increased, it becomes possible to detect the relative position with high accuracy even in the direction detection process.

In each embodiment, the number of out-of-parking directions that the user can specify is not limited to two. For example, three or more candidate directions may be displayed, so that the user can select among the candidate directions.

In each embodiment, the detection process is not limited to the first distance measurement process, the second distance measurement process, and the direction detection process, and may be any process for detecting a relative position using wireless communication between the communication terminal 21 and the sensor unit 27.

In each embodiment, the sensor unit 27 is not limited to a ToF sensor and may be any sensor that can detect a position through communication.

In each embodiment, the user may change the out-of-parking target position Pa during the process.

In each embodiment, when updating the out-of-parking target position Pa, for example, if a detection process with a high reliability becomes possible, a detection process with a lower reliability may be terminated.

In each embodiment, when a detection process with the higher reliability is not possible, a method may be performed such that the detection processes are tried in descending order of the reliability so as to perform a detection process with reliability lower than the higher reliability.

In each embodiment, the distance measurement and the direction detection may be performed using Bluetooth communication. In this case, the communication function for the UWB communication can be omitted.

In the second embodiment, the method of photographing the vehicle 2 with the communication terminal 21 and calculating the out-of-parking target position Pa is not limited to the method based on the distance measurement or the direction detection. In other words, a method may be used in which the out-of-parking target position Pa is calculated simply by photographing the vehicle 2 with the communication terminal 21.

In each embodiment, the detection process is not limited to including the first detection process, the second detection process, and the direction detection process. For example, a method may be used in which the out-of-parking target position Pa is calculated only by the second detection process.

In each embodiment, the information acquisition unit 16, the vehicle control unit 17, the out-of-parking target calculation unit 28, the state management unit 31, the validity check unit 32, and the vehicle direction detection unit 44 may be configured by: [1] one or more processors that operate according to a computer program (i.e., software), or [2] a combination of such a processor and one or more dedicated hardware circuits, such as an application specific integrated circuit (i.e., ASIC), that executes at least some of the various processes. A processor includes a CPU and a memory, such as RAM and ROM, that stores program code, or instructions, configured to cause the CPU to perform processes. The memory (i.e., computer-readable medium) includes any available medium that can be accessed by a general purpose computer or special purpose computer. Alternatively, instead of a computer including the above-described processor, a processing circuit configured with one or more dedicated hardware circuits that execute all of the various processes may be used.

In each embodiment, the information acquisition unit 16, the vehicle control unit 17, the out-of-parking target calculation unit 28, the state management unit 31, the validity check unit 32, and the vehicle direction detection unit 44 may be configured by independent processors, or some of the functions may be configured by a shared processor. In this way, the information acquisition unit 16, the vehicle control unit 17, the out-of-parking target calculation unit 28, the state management unit 31, the validity check unit 32, and the vehicle direction detection unit 44 are not limited to being independent functional blocks, but may be configured by a single functional block or some of the functions may be configured by a shared functional block.

In each of the embodiments, although the present disclosure has been described in accordance with the above embodiments, it is understood that the present disclosure is not limited to the above embodiments and configurations. The present disclosure also includes various modification examples and modifications within an equivalent range. In addition, while the various combinations and configurations, which are preferred, other combinations and configurations, including more, less or only a single element, are also within the spirit and scope of the present disclosure.

Next, the technical features that can be understood from the above embodiments and modified examples will be described.

(A) An automatic system for getting out of a parking area that automatically drives a vehicle to get out of a parking area toward a location required by an user when requesting the getting out of the parking area with respect to a parked vehicle. The automatic system calculates an angle of the communication terminal with respect to the vehicle based on a change in a distance calculated by wireless communication between a communication terminal carried by a user and at least one of a plurality of sensor units provided on a vehicle body, a vehicle speed of the vehicle, and a steering direction of the vehicle. The automatic system determines a direction of the communication terminal relative to the vehicle based on a received signal intensity of a radio wave measured by the wireless communication between each of the plurality of sensor units and the communication terminal. The automatic system for getting out of a parking area includes: a position detection unit that detects a relative position between the vehicle and the communication terminal based on the angle and the direction; an out-of-parking target calculation unit that calculates an out-of-parking target position based on a detection result of the position detection unit; and a vehicle control unit that controls an autonomous driving operation of the vehicle to get out of a parking area toward the out-of-parking target position.

Here, each of the vehicle and the communication terminal calculates its own absolute position using a GPS. During the process for getting out of the parking area, the exit position is determined by calculating the relative position relationship between the absolute position of the vehicle and the absolute position of the communication terminal. For this reason, since it may not be possible to detect the absolute position inside a building and the like, there is a possibility not executing the automatic getting out of the parking area. On the other hand, according to the present embodiments, the position relationship between the vehicle and the communication terminal is detected as a relative position, so that the out-of-parking target position can be set even inside a building. This configuration improves user convenience.

(B) An automatic system for getting out of a parking area that automatically drives a vehicle to get out of a parking area toward a location required by an user when requesting the getting out of the parking area with respect to a parked vehicle. The automatic system for getting out of a parking area includes: a position detection unit that detects a relative position between the vehicle and the communication terminal based on photograph information of the vehicle photographed by a photograph unit provided in the communication terminal carried by a user; an out-of-parking target calculation unit that calculates an out-of-parking target position based on a detection result of the position detection unit; and a vehicle control unit that controls an autonomous driving operation of the vehicle to get out of a parking area toward the out-of-parking target position.

Here, each of the vehicle and the communication terminal calculates its own absolute position using a GPS. During the process for getting out of the parking area, the exit position is determined by calculating the relative position relationship between the absolute position of the vehicle and the absolute position of the communication terminal. For this reason, since it may not be possible to detect the absolute position inside a building and the like, there is a possibility not executing the automatic getting out of the parking area. On the other hand, according to the present embodiments, the position relationship between the vehicle and the communication terminal is detected as a relative position, so that the out-of-parking target position can be set even inside a building. This configuration improves user convenience.

In the present disclosure, the term “processor” may refer to a single hardware processor or several hardware processors that are configured to execute computer program code (i.e., one or more instructions of a program). In other words, a processor may be one or more programmable hardware devices. For instance, a processor may be a general-purpose or embedded processor and include, but not necessarily limited to, CPU (a Central Processing Circuit), a microprocessor, a microcontroller, and PLD (a Programmable Logic Device) such as FPGA (a Field Programmable Gate Array).

The term “memory” in the present disclosure may refer to a single or several hardware memory configured to store computer program code (i.e., one or more instructions of a program) and/or data accessible by a processor. A memory may be implemented using any suitable memory technology, such as static random-access memory (SRAM), synchronous dynamic RAM (SDRAM), nonvolatile/Flash-type memory, or any other type of memory. Computer program code may be stored on the memory and, when executed by a processor, cause the processor to perform the above-described various functions.

In the present disclosure, the term “circuit” may refer to a single hardware logical circuit or several hardware logical circuits (in other words, “circuitry”) that are configured to perform one or more functions. In other words (and in contrast to the term “processor”), the term “circuit” refers to one or more non-programmable circuits. For instance, a circuit may be IC (an Integrated Circuit) such as ASIC (an application-specific integrated circuit) and any other types of non-programmable circuits.

In the present disclosure, the phrase “at least one of (i) a circuit and (ii) a processor” should be understood as disjunctive (logical disjunction) where the circuit and the processor can be optional and not be construed to mean “at least one of a circuit and at least one of a processor”. Therefore, in the present disclosure, the phrase “at least one of a circuit and a processor is configured to cause an automatic system for getting out of a parking area to perform functions” should be understood that (i) only the circuit can cause an automatic system for getting out of a parking area to perform all the functions, (ii) only the processor can cause an automatic system for getting out of a parking area to perform all the functions, or (iii) the circuit can cause an automatic system for getting out of a parking area to perform at least one of the functions and the processor can cause an automatic system for getting out of a parking area to perform the remaining functions. For instance, in the case of the above-described (iii), function A and B among the functions A to C may be implemented by a circuit, while the remaining function C may be implemented by a processor.

It is noted that a flowchart or the processing of the flowchart in the present application includes sections (also referred to as steps), each of which is represented, for instance, as S101. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An automatic system for getting out of a parking area that automatically drives a vehicle parked at the parking area to get out of the parking area toward a location required by an user when requesting an out-of-parking request with respect to the vehicle, the automatic system comprising:
a position detection unit that detects a relative position between a communication terminal carried by the user and the vehicle according to any one of a plurality of detection processes corresponding to a communication state among the plurality of detection processes using a wireless communication between the communication terminal and one or more of sensor units mounted on a vehicle body of the vehicle;
an out-of-parking target calculation unit that sets an out-of-parking target position based on a detection result of the position detection unit, and calculates an optimum out-of-parking target position by updating the out-of-parking target position based on the detection result of the position detection unit when a position detection is performed in the any one of the plurality of detection processes with a reliability higher than the out-of-parking target position currently set while getting out of the parking area; and
a vehicle control unit that controls an autonomous driving operation of the vehicle to get out of a parking area toward the out-of-parking target position, wherein:
the plurality of the detection processes includes:
a distance measurement detection process for detecting a distance between the communication terminal and each of the one or more sensor units by the wireless communication and determining the relative position between the vehicle and the communication terminal; and
a direction detection process for determining a direction of the communication terminal with respect to the vehicle by the wireless communication and determining the relative position between the vehicle and the communication terminal; and
the distance measurement detection process has a reliability of the position detection higher than the direction detection process.

2. The automatic system for getting out of the parking area according to claim 1, wherein:
the distance measurement detection process includes:
a first distance measurement process for determining the relative position between the vehicle and the communication terminal according to a plurality of distances acquired by the wireless communication between each of the one or more of the sensor units and the communication terminal; and
a second distance measurement process for determining the relative position between the vehicle and the communication terminal according to a change in a distance acquired by the wireless communication between one of the one or more of the sensor units and the communication terminal.

3. The automatic system for getting out of the parking area according to claim 1, wherein:
the out-of-parking target calculation unit identifies the reliability of the detection process based on a numerical number of the one or more of the sensor units that establish the wireless communication with the communication terminal.

4. The automatic system for getting out of the parking area according to claim 1, wherein:
the out-of-parking target calculation unit identifies the reliability of the detection process based on a received signal intensity of a radio wave communicated between the communication terminal and the one or more of the sensor units.

5. The automatic system for getting out of the parking area according to claim 1, wherein:
the out-of-parking target calculation unit updates the out-of-parking target position based on distance measurement information acquired from the position detection unit during getting out of the parking area when distance measurement is succeeded using the detection process with an equivalent reliability of the reliability currently set, or when the distance measurement is succeeded using the detection process with a higher reliability than the reliability currently set.

6. The automatic system for getting out of the parking area according to claim 1, wherein:
the out-of-parking target calculation unit updates the out-of-parking target position based on a travel amount of the vehicle during getting out of the parking area when distance measurement is succeeded using the detection process with a lower reliability than the reliability currently set, or when the distance measurement is not established.

7. The automatic system for getting out of the parking area according to claim 1, further comprising:
an information acquisition unit that acquires vehicle periphery information from a detection unit provided in the vehicle to acquire a situation around the vehicle.

8. The automatic system for getting out of the parking area according to claim 7, further comprising:
a state management unit that terminates the getting out of the parking area for the vehicle when it is determined based on the vehicle periphery information that the vehicle is in a state in which the vehicle can not get out of the parking area.

9. The automatic system for getting out of the parking area according to claim 7, further comprising:
an all around camera that captures an image of a periphery of the vehicle, wherein:
the vehicle periphery information includes photograph information photographed by the all around camera; and
the out-of-parking target calculation unit sets the out-of-parking target position using the photograph information added thereon.

10. The automatic system for getting out of the parking area according to claim 7, wherein:
the out-of-parking target position is normally set to a position where a door of a driver seat of the vehicle is disposed in front of the user; and
when the out-of-parking target calculation unit determines based on the vehicle periphery information that it is not possible to set the out-of-parking target position where the door of the driver seat of the vehicle is disposed in front of the user, the out-of-parking target calculation unit sets the out-of-parking target position where another door different from the door of the driver seat of the vehicle is disposed in front of the user.

11. The automatic system for getting out of the parking area according to claim 1, further comprising:
a validity check unit that, when starting to get out of the parking area, transmits information about automatic getting out of the parking area from the vehicle to the communication terminal to cause a display of the communication terminal to display a position or a direction for getting out of the parking area, and requires the user to check a validity of the out-of-parking target position.

12. The automatic system for getting out of the parking area according to claim 1, wherein:
the position detection unit includes a first position detection unit provided in the vehicle and a second position detection unit provided in the communication terminal;
when the first position detection unit is unable to perform the position detection, the second position detection unit determines the relative position between the communication terminal and the vehicle based on photograph information of the vehicle photographed by a photograph unit provided in the communication terminal; and
the out-of-parking target calculation unit sets the out-of-parking target position based on the relative position determined by the photograph information.

13. The automatic system for getting out of the parking area according to claim 12, wherein:
the communication terminal includes a vehicle direction detection unit that monitors a traveling direction of the vehicle when the vehicle is getting out of the parking area toward the out-of-parking target position set by the photograph information; and
the vehicle control unit forcibly terminates getting out of the parking area for the vehicle when a detection result of the vehicle direction detection unit is different from the traveling direction of the vehicle.

14. The automatic system for getting out of the parking area according to claim 12, wherein:
when the vehicle is getting out of the parking area toward the out-of-parking target position set by the photograph information, if the position detection by the first position detection unit becomes possible, the out-of-parking target calculation unit updates the out-of-parking target position by also using a detection result of the first position detection unit added thereon.

15. The automatic system for getting out of the parking area according to claim 1, wherein:
the getting out of the parking area for the vehicle includes:
a forward getting out of the parking area in which the vehicle parked in reverse at the parking area moves forward toward the out-of-parking target position; and
a rear getting out of the parking area in which the vehicle parked forward at the parking area moves backward to exit a parking space, and then, moves forward toward the out-of-parking target position.

16. The automatic system for getting out of the parking area according to claim 1, wherein:
the vehicle control unit causes the vehicle to get out of the parking area toward the out-of-parking target position where a rear of the vehicle is disposed in front of the user when an out-of-parking direction selected by the user is opposite to the out-of-parking direction defined by the out-of-parking target position.

17. The automatic system for getting out of the parking area according to claim 1, further comprising:
at least one of (i) a circuit and (ii) a processor having a memory storing computer program code, wherein:
the at least one of the circuit and the processor having the memory is configured to cause the automatic system to provide at least one of: the position detection unit; the out-of-parking target calculation unit; and the vehicle control unit.

18. An automatic method for getting out of a parking area used in an automatic system for getting out of a parking area that automatically drives a vehicle parked at the parking area to get out of the parking area toward a location required by an user when requesting an out-of-parking request with respect to the vehicle, the automatic method comprising:
detecting a relative position between a communication terminal carried by the user and the vehicle according to any one of a plurality of detection processes corresponding to a communication state among the plurality of detection processes using a wireless communication between the communication terminal and one or more of sensor units mounted on a vehicle body of the vehicle;
setting an out-of-parking target position based on a detection result of the position detection, and calculating an optimum out-of-parking target position by updating the out-of-parking target position based on the detection result of the position detection when the position detection is performed in the any one of the plurality of detection processes with a reliability higher than the out-of-parking target position currently set while getting out of the parking area; and
controlling an autonomous driving operation of the vehicle to get out of the parking area toward the out-of-parking target position, wherein:
the plurality of the detection processes includes:
a distance measurement detection process for detecting a distance between the communication terminal and each of the one or more sensor units by the wireless communication and determining the relative position between the vehicle and the communication terminal; and
a direction detection process for determining a direction of the communication terminal with respect to the vehicle by the wireless communication and determining the relative position between the vehicle and the communication terminal; and
the distance measurement detection process has a reliability of the position detection higher than the direction detection process.

19. An automatic system for getting out of a parking area that automatically drives a vehicle parked at the parking area to get out of the parking area toward a location required by an user when requesting an out-of-parking request with respect to the vehicle, the automatic system comprising:
at least one of (i) a circuit and (ii) a processor having a memory storing computer program code,
wherein the at least one of the circuit and the processor having the memory is configured to cause the automatic system to:
detect a relative position between a communication terminal carried by the user and the vehicle according to any one of a plurality of detection processes corresponding to a communication state among the plurality of detection processes using a wireless communication between the communication terminal and one or more of sensor units mounted on a vehicle body of the vehicle;
set an out-of-parking target position based on a detection result of the position detection, and calculating an optimum out-of-parking target position by updating the out-of-parking target position based on the detection result of the position detection when the position detection is performed in the any one of the plurality of detection processes with a reliability higher than the out-of-parking target position currently set while getting out of the parking area; and
control an autonomous driving operation of the vehicle to get out of the parking area toward the out-of-parking target position, wherein:
the plurality of the detection processes includes:
a distance measurement detection process for detecting a distance between the communication terminal and each of the one or more sensor units by the wireless communication and determining the relative position between the vehicle and the communication terminal; and
a direction detection process for determining a direction of the communication terminal with respect to the vehicle by the wireless communication and determining the relative position between the vehicle and the communication terminal; and
the distance measurement detection process has a reliability of the position detection higher than the direction detection process.
